(19) United States
(12) Patent Application Publication
(10) Pub. No.: US 2011/0135983 A1
(43) Pub. Date: Jun. 9, 2011

(54) BATTERY COVER LATCHING MECHANISM AND PORTABLE ELECTRONIC DEVICE USING THE SAME

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/821,269

(22) Filed: Jun. 23, 2010

(30) Foreign Application Priority Data
Dec. 9, 2009 (CN) 200910311120.2

(51) Int. Cl. H01M 2/10

(52) U.S. Cl. 429/97

(57) ABSTRACT

A battery cover latching mechanism and a portable electronic device using the same are provided. The portable electronic device includes a housing, a battery, and a battery cover latching mechanism detachably fixing the battery cover to the housing. The battery cover latching mechanism includes a latching piece assembled to the housing and a latching post integrally formed on the battery cover. The latching piece includes a connecting body and two elastic arms extending from two ends of the connecting body opposite to each other to form a latching space. The latching post detachably latches in the latching area of the latching piece.

### BACKGROUND

1. Technical Field

The present disclosure relates to cover latching mechanisms and, particularly, to a battery cover latching mechanism used in a portable electronic device.

2. Description of Related Art

Batteries are widely used in portable electronic devices, such as personal digital assistants (PDAs), mobile phones, and so on. Conventional batteries are attachably received in the electronic device, and battery covers are designed to connect with housings of the electronic devices to package the batteries. Batteries are replaced by opening the battery covers when, for example, the batteries are damaged and/or dead (i.e. no longer rechargeable).

Although battery cover assemblies may be simple, engagement between the battery cover and the housing of the mobile phone can be too firm to be easily undone.

Therefore, there is room for improvement within the art.

### BRIEF DESCRIPTION OF THE DRAWINGS

Many aspects of the present disclosure can be better understood with reference to the following drawings. These drawings are not necessarily drawn to scale, the emphasis instead being placed upon clearly illustrating the principles of the present battery cover latching mechanism and portable electronic device using the same. Moreover, in the drawings like reference numerals designate corresponding sections throughout the several views.

FIG. 1 shows an assembled, isometric view of a portable electronic device employing a battery cover latching mechanism in accordance with an exemplary embodiment;

FIG. 2 shows an exploded, isometric view of the portable electronic device of FIG. 1.

FIG. 3 shows a cross-sectional view of the portable electronic device of FIG. 1 taken along line III-III.

### DETAILED DESCRIPTION

In this exemplary embodiment, the battery cover latching mechanism is applied to a mobile telephone. The mobile telephone described herein is a representation of one type of portable electronic device that may benefit from the exemplary embodiment. However, it is to be understood that the exemplary embodiment may be applied to any type of hand-held or portable electronic device including, but not limited to, the following devices: radiotelephones, cordless phones, paging devices, personal digital assistants, portable computers, portable media players (such as an MP3 or DVD player) and the like. Accordingly, any reference herein to the mobile telephone should also be considered to apply equally to other portable wireless electronic devices.

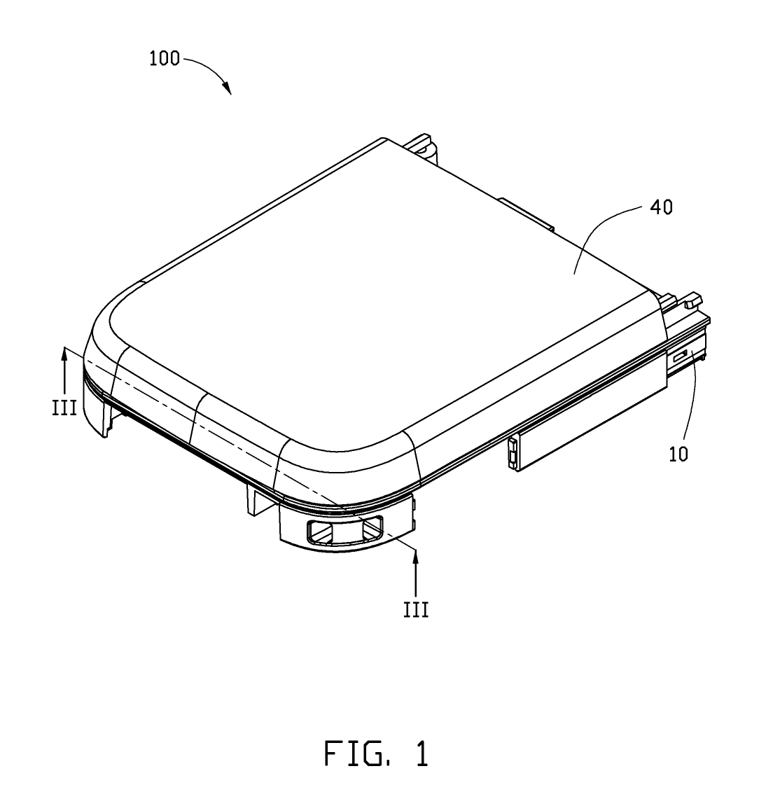

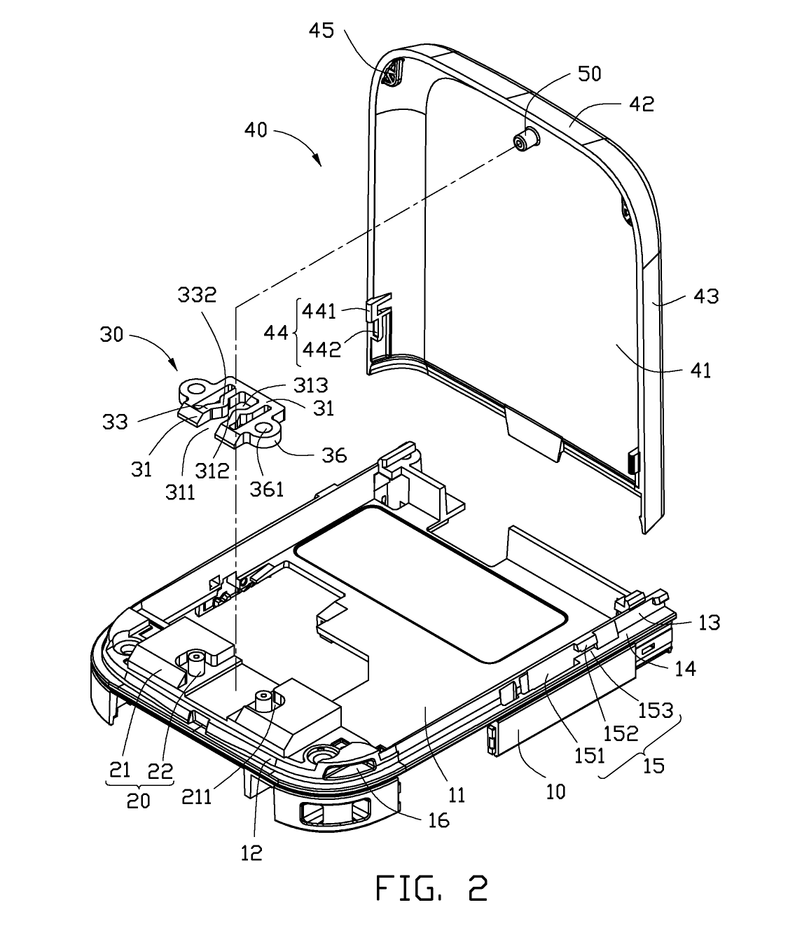

FIGS. 1 and 2 show a portable electronic device 100 including a housing 10, a battery cover 40, and a battery cover latching mechanism configured for detachably latching the battery cover 40 to the housing 10.

The housing 10 includes a base board 11, an end wall 12, and two opposite sidewalls 13 substantially perpendicularly connected to opposite ends of the end wall 12. The base board 11, the end wall 12, and the two opposite sidewalls 13 cooperatively form a battery accommodating cavity for receiving a battery (not shown). An assembling portion 20 is formed on the base board 11 adjacent to the end wall 12 for attaching the battery cover latching mechanism to the base board 11. The assembling portion 20 includes a support 21 and two fixing posts 22. The support 21 protrudes from the base board 11 adjacent to the end wall 12 and defines an assembling cavity 211 recessed therein. The two fixing posts 22 project from the bottom of the assembling cavity 211 and are respectively positioned adjacent to opposite sides of the assembling cavity 211.

The end wall 12 and the two sidewalls 13 are substantially step shaped and together form an assembling surface 14 surrounding the housing 10, for mounting the battery cover 40 thereon. Two latching portions 15 are formed on the outer surfaces of the two sidewalls 13 respectively, away from the end wall 12. Each latching portion 15 includes a sliding groove 151 longitudinally recessed in the assembling surface 14 of the sidewalls 13, and a latching block 152 protruding from the sidewalls 13 adjacent to the sliding groove 151 and parallel to the assembling surface 14. The latching block 152, the assembling surface 14, and the sidewalls 13 cooperatively form a latching slot 153. Two latching holes 16 are recessed in the sidewalls 13 adjacent to where the two sidewalls 13 meet the end wall 12.

The battery cover latching mechanism includes a latching piece 30 and a latching post 50. The latching piece 30 is assembled to the assembling portion 20 of the housing 10 and received within the assembling cavity 211. The latching piece 30 can be made of a resilient material such as rubber and has substantially the same outer shape as the assembling cavity 211. The latching piece 30 includes a connecting body 31, two elastic arms 33, and two fixing bodies 36. Each elastic arm 33 extends perpendicularly from one end of the connecting body 31 and is positioned opposite to the other to define a substantially U-shaped latching space. Each elastic arm 33 includes an arcuate resisting portion 332 formed at substantially the middle portion thereof opposite to each other, such that the U-shaped latching space is divided into an opening area 311, a resisting area 312, and a latching area 313. The two fixing bodies 36 extend from the two distal ends of the connecting body 31 and connect to the distal ends of the two elastic arms 33 respectively. Each fixing body 36 defines a fixing hole 361 therethrough corresponding to the two fixing posts 22 of the housing 10. The latching post 50 is substantially cylindrical and integrally formed on the battery cover 40 for latching the battery cover 40 to the housing 10.

The battery cover 40 detachably attaches to the housing 10 by the battery cover latching mechanism and includes a cover body 41, a terminal wall 42, and two lateral walls 43 extending from the periphery of the cover body 41. The latching post 50 protrudes from the inner surface of the cover body 41 adjacent to the terminal wall 42. Two latching bodies 44 are formed at the two lateral walls 43 of the battery cover 40, respectively, opposite to each other and corresponding to the two latching portions 15 of the housing 10. Each latching body 44 includes a sliding block 441 and a latching arm 442 protruding from the inner surface of the lateral wall 43 of the battery cover 40 corresponding to the sliding groove 151 and the latching block 152 respectively. Two catches 45 are formed on the opposite lateral walls 43 of the battery cover 40 adjacent to the two joints of the lateral walls 43 and the terminal wall 42. The two catches 45 are configured for inserting into the two latching holes 16 of the housing 10 respectively.

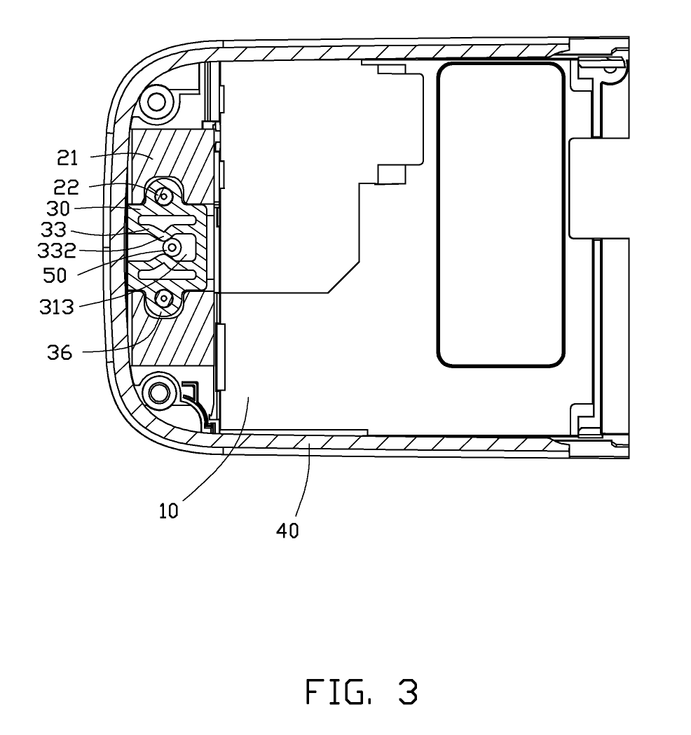

Referring to FIGS. 2 and 3, in assembly, when the latching piece 30 is fixedly assembled to the assembling portion 20 of the housing 10, the latching piece 30 is received in the assembling cavity 211 and the two fixing bodies 36 are fixed to the two fixing posts 22 respectively with the two fixing posts 22 penetrating the corresponding two fixing holes 361. The battery cover 40 is placed above the housing 10. The two catches 45 are aimed at the two latching holes 16 of the housing 10 respectively, and the two latching bodies 44 are inserted into their respective sliding grooves 151 of the latching portions 15 of the housing 10. The latching post 50 is located in the opening area 311 of the latching piece 30 correspondingly. By pushing the battery cover 40 longitudinally and then sliding the battery cover 40 relative to the housing 10, the battery cover 40 is moved toward the latching portions 15 end, and the latching post 50 resists against the two resisting portions 332 and moves passed the resisting area 312 and latches in the latching area 313 of the latching piece 30. Thus, the latching post 50 is locked within the latching area 313 by the two resisting portions 332 of the resisting area 312. The two catches 45 latch in their respective latching holes 16 of the housing 10, the two sliding blocks of the latching bodies 44 slide within the corresponding sliding grooves 151, and each latching arm 442 latches to the corresponding latching block 152. Then, the battery cover 40 is tightly assembled to the housing 10.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery cover latching mechanism configured for detachably assembling a battery cover to a housing, comprising:
a latching piece assembled to the housing, the latching piece including a connecting body and two elastic arms extending from opposite ends of the connecting body to form a latching space therebetween;
a latching post integrally formed on the battery cover and detachably latching in the latching piece.

2. The battery cover latching mechanism as claimed in claim 1, wherein the latching piece is made of elastic material, each elastic arm includes an arcuate resisting portion formed at substantially the middle portion thereof opposite to the other, such that the latching space is divided into an opening area, a resisting area and a latching area, the latching post is configured to be locked within the latching area.

3. The battery cover latching mechanism as claimed in claim 1, wherein the latching piece further includes two fixing bodies extending from the two distal ends of the connecting body and connecting to the distal ends of the two elastic arms respectively, the two fixing bodies are configured to be fixed to the housing.

4. The battery cover latching mechanism as claimed in claim 3, wherein each fixing body defines a fixing hole therethrough, the housing includes two fixing posts protruding therefrom and configured to fix with the corresponding two fixing holes respectively.

5. A portable electronic device, comprising:
a housing;
a battery cover having a latching post integrally formed thereon;
a battery cover latching mechanism detachably latching the battery cover to the housing and comprising a latching piece assembled to the housing, the latching piece including a connecting body and two elastic arms extending from opposite ends of the connecting body to form a latching space therebetween; the latching post detachably latching in the latching piece.

6. The battery cover latching mechanism as claimed in claim 5, wherein each elastic arm includes an arcuate resisting portion formed thereon opposite to the other, such that the latching space is divided into an opening area, a resisting area and a latching area, the latching post is configured to be locked within the latching area.

7. The battery cover latching mechanism as claimed in claim 6, wherein the housing includes a base board and an end wall, an assembling portion is formed on the base board adjacent to the end wall; the latching piece is fixedly mounted on the assembling portion;
the battery cover includes a cover body and a terminal wall, the latching post protrudes from the inner surface of the cover body adjacent to the terminal wall corresponding to the assembling portion of the housing.

8. The battery cover latching mechanism as claimed in claim 7, wherein the latching piece further includes two fixing bodies extending from the two distal ends of the connecting body and connecting to the distal ends of the two elastic arms respectively, the assembling portion includes a support protruding from the base board adjacent to the end wall and having an assembling cavity recessed therein; the latching piece is accommodated within the assembling cavity.

9. The battery cover latching mechanism as claimed in claim 8, wherein the assembling portion further includes two fixing posts projecting from the bottom of the assembling cavity and positioned adjacent opposite sides thereof; each fixing body defines a fixing hole therethrough, the two fixing posts penetrate into be fixed within the two fixing holes respectively.

10. The battery cover latching mechanism as claimed in claim 7, wherein the battery cover further includes two lateral walls, the housing further includes two opposite sidewalls connecting with the two ends of the end wall, the end wall and the two sidewalls are substantially step shaped and together form an assembling surface surrounding the housing, for mounting the battery cover thereon.

11. The battery cover latching mechanism as claimed in claim 10, wherein the housing further includes two latching portions formed on the outer surface of the two sidewalls respectively; the battery cover further includes two latching bodies formed at the two lateral walls respectively opposite to each other configured for latching with the two latching portions of the housing.

12. The battery cover latching mechanism as claimed in claim 11, wherein each latching portion includes a sliding groove longitudinally recessed in the assembling surface of the sidewall, each latching body includes a sliding block protruding from the lateral wall of the batter cover and configured to be inserted into and slide within the sliding groove.

13. The battery cover latching mechanism as claimed in claim 12, wherein the latching portion further includes a latching block protruding from the sidewall adjacent to the sliding groove; the latching body further includes a latching arm protruding from the lateral wall of the batter cover, the latching arm latches with the corresponding latching block.

14. The battery cover latching mechanism as claimed in claim 10, wherein the housing further includes two latching holes recessed in the sidewalls adjacent to the two joints of the sidewalls and the end wall; the battery cover further includes two catches formed on the opposite lateral walls of the battery cover adjacent to the two joints of the lateral walls and the terminal wall; the two catches are configured for inserting into the two latching holes of the housing respectively.
